(19) United States
(12) Patent Application Publication
(10) Pub. No.: US 2012/0065121 A1
(43) Pub. Date: Mar. 15, 2012

(54) POST-CARBONATED CLEANING COMPOSITION AND METHOD OF USE

(76) Inventor: JEFFREY NEIL EBBERTS, Ardmore, OK (US)

(21) Appl. No.: 13/195,282

(22) Filed: Aug. 1, 2011

Related U.S. Application Data
(60) Provisional application No. 61/400,737, filed on Aug. 2, 2010.

(51) Int. Cl. C11D 3/60

(52) U.S. Cl. 510/478; 510/477; 510/488

(57) ABSTRACT

A post-carbonated cleaning solution which is prepared by first mixing at least one acid and two or more carbonate salts in an effective amount of water in such a manner that the carbon dioxide caused by the chemical reaction of the mixture is allowed to escape the solution. The resulting post-carbonated solution is a multiple surface cleaning composition that does not need to be maintained in a pressurized vessel and has a toxicity level of less than one. It uses none of the typical cleaning compounds to effect proper cleaning This post carbon dioxide aqueous solution can be concentrated to a point of near chemical saturation and the pH can be incrementally adjusted from about 3 to about 11. Citric acid is the preferred solid acid and sodium bicarbonate and sodium carbonate are the preferred carbonate salts.

### CROSS-REFERENCES TO RELATED APPLICATIONS

The patent application claims priority based upon the following Provisional Patent Application No. 61/400,737, filed on Aug. 2, 2010.

### BACKGROUND OF THE INVENTION

The present patent application relates to carbonated cleaning compositions. More particularly, this invention relates to cleaning compositions that are created by a chemical reaction that releases carbon dioxide. The carbon dioxide is allowed to fully dissipate resulting in a cleaning composition that can be easily stored, shipped, concentrated and otherwise manipulated for various cleaning tasks that carbonation is not essential for or may actually impede or otherwise interfere with. Additionally, the carbon dioxide that is produced during manufacturing is available to be recycled rather than expelled into the atmosphere.

Advances in cleaning technology, and more particularly textile cleaning technology, have long recognized that carbonation added to a cleaning solution can minimize the need for harmful cleaning agents and improve the drying times of carpets, upholstery, drapes and other textile type products; see U.S. Pat. Nos. 4,219,333 and 5,244,468.

It has also been taught that a method of applying heat to a carbonated solution can increase the cleaning ability and the drying times of a textile fabric; see U.S. Pat. Nos. 5,624,468, 5,718,729 and 5,593,091.

An additional improvement in the art has shown that for cleaning textiles a self-carbonating solution could eliminate the need for cleaning agents per se and provide a superior cleaning result, as demonstrated in U.S. Pat. No. 6,126,697.

In all of the preceding relevant art it has been thoroughly taught that the effervescing action of carbon dioxide, for the emulsification and removal of soils in the cleaning process, is essential to the overall cleaning ability of the solution.

This led to the belief that it was therefore worth the effort to maintain the carbonation in the cleaning solution, which in turn has led to the use of cumbersome pressurized containers that inject gaseous carbon dioxide into a cleaning solution, or equipment that prevents carbon dioxide from escaping prematurely once the solution is carbonated. The need to maintain carbon dioxide in the cleaning solution necessarily involved even more elaborate delivery systems that actually delay the carbonation reaction until it is applied, or just before it is applied, to the textile surface, as found in U.S. Pat. Nos. 5,593,091 and 6,554,207.

Most recently, in an effort to overcome the challenges created by trying to heat a carbonated solution in such a manner as to maintain its effervescing reaction after it is applied to a textile, it is taught that using acids that dissolve more slowly in water would increase the amount of carbon dioxide actually available to the textile fabric. This is shown in patent applications #20060005316 and #20070028394 and reinforces the understanding that carbonation is essential to cleaning

The prior art clearly teaches away from the current invention. Additionally, the focus of the relevant art cited has all been related to uses in textile cleaning and while this has shown remarkable improvement in a very narrow segment of the cleaning industry the instant invention has application for a much wider use of cleaning tasks.

### DISCLOSURE OF THE INVENTION

It is therefore an objective of the present invention to provide a cleaning compound with improved cleaning applications over the carbonated solutions of the prior art.

It is an objective of the present invention to provide a cleaning composition that does not need to be maintained in a pressurized vessel.

It is an objective of the present invention to provide a cleaning solution with the ability to clean multiple surfaces.

It is an objective of the present invention to provide a cleaning solution with the ability to clean substances that currently require toxic chemicals to remove.

It is an objective of the present invention to provide a cleaning solution with greater versatility than other carbonated cleaners.

It is an objective of the present invention to provide a cleaning solution that requires no additional cleaning agents or additives such as solvents, surfactants, soaps or detergents.

It is an objective of the present invention to provide a cleaning solution that has a neutral pH.

It is a further objective of the present invention to provide a cleaning solution in which the pH can be adjusted from about 3 to about 11.

It is a further objective of the present invention to provide a post-carbonated cleaning solution that can be concentrated or diluted to alter its cleaning abilities and applications.

It is a further objective of the present invention to provide a hard surface cleaner that is safe and non-toxic.

It is a further objective of the present invention to provide a solution that can clean delicate surfaces.

It is a further objective of the present invention to provide a solution that will reduce the cost of application.

It is a further objective of the present invention to eliminate the use of CO2 in the open environment.

It is a further objective of the present invention to release CO2 from the resulting compound in a controlled manner.

It is a further objective of the present invention to recycle the generated CO2 for a useful and beneficial application.

### SUMMARY OF THE INVENTION

These and other objectives are accomplished by means of a cleaning solution which is prepared by combining an effective amount of an acid or acid forming material which is natural and non-polluting to the environment, such as citric acid, succinic acid, tartaric acid, adipic acid, oxalic acid, glutaric acid, etc., with a mixture of two or more carbonate, bicarbonate or percarbonate salts, so that the carbonates produce carbon dioxide when reacted with the acid, the chemical reaction creating or producing an effective cleaning composition in and of itself.

An acid and a carbonate added to water create an effervescing reaction with the release of gaseous carbon dioxide. This bubbling action has been found beneficial in the cleaning of textiles. The benefit to the cleaning of textiles, specifically carpet and upholstery, has been so great that any use of such solutions, without active carbonation has been, and is currently being taught away from.

The present invention teaches that the resulting solutions from such reactions, after the carbon dioxide has dissipated, is able to perform a wider variety of cleaning tasks not previously considered and on a range of medium or surfaces previously unavailable to a carbonated cleaner.

Once the chemical reaction is complete; that is, the carbon dioxide that was generated is expelled from the solution and maintaining carbonation in the solution is no longer a consideration; the resulting solution can be profoundly manipulated.

This release of carbon dioxide allows the cleaner to be used in virtually any existing cleaning system that lifts or extracts liquids or solids from a surface.

While it has been taught that a mixture of acid with a carbonate, a bicarbonate or a percarbonate salt in an aqueous solution is useful in the generation of carbon dioxide and that the subsequent carbonation is a substantial aid in cleaning textiles, a mixture of an acid and two or more carbonates, bicarbonates and percarbonates as a cleaning agent per se has only been suggested for use in cleaning textiles and then only in conjunction with the carbon dioxide that such a mixture produces.

The notion that a post-carbonated solution, that contains none of the typical cleaning agents used in the industry today, could be in and of itself an improvement in the art of cleaning, not only to textiles but to multiple surface types and textures and maintain a passive neutral effect on the environment, has not been considered or previously taught whether by the inventor or by the prior art.

It is understood in the industry that a high or low pH is necessary to effect proper cleaning of certain substances. While the '697 patent has dispelled that in part the need for a variable pH cleaner still persists. Until the present invention a cleaning solution that had a pH as low as 3 or as high as 11, that was non toxic, safe, required no additional cleaning agents and is effective at removing soils, oils and contaminates from surfaces and textiles, was not known in the industry.

These and other objectives of the invention may be more clearly seen from the detailed description of the preferred embodiment that follows.

### DETAILED DESCRIPTION OF THE PREFERRED EMBODIMENT

Through subsequent usage and testing it is found that preparing a cleaning composition by admixing by volume about 150 grams of an alkaline metal bicarbonate or per-carbonate salt, about 57.4 grams of a carbonate salt and about 165 grams of a natural solid acid in an aqueous medium to create a carbonating solution with a neutral pH, the solids comprising by volume 1% to 5% of the composition, as described in U.S. Pat. No. 6,126,697, as the control, specific modifications can generate a wide range of positive results.

By allowing the carbon dioxide to escape from the solution and become flat or non-effervescing the solution still retains a surprising ability to clean textiles. The carbonation, while useful in some circumstances in not necessary or beneficial in others. Gummy or oily substances for example do not respond well to effervescing actions but do respond to the natural penetrative action of a water based solution containing a mixture of salts and acids.

The solids in the solution, in the above listed ratio, can be increased by at least 40 times making it a highly concentrated solution that can be easily stored or shipped in liquid form and then diluted to a desired consistency before use. That this cleaning solution could be concentrated and subsequently reconstituted was heretofore unknown in the industry.

By using the formulation found in the '697 patent as control, concentrating or diluting the solution allows for cleaning other surfaces besides textiles; such as tile, ceramic, stone, grout, fiberglass, metal, wood, formica, where a higher or lower pH might give a better cleaning result. Such surfaces are routinely cleaned by more toxic and harmful products containing solvents and polymer blends that are hazardous to both the environment and to the technician performing the work.

When the specific ratios of acids to carbonate and carbonate salts are adjusted the resulting pH can be changed also. For example a ratio of 50 grams of an organic acid to 107.5 grams of a carbonate salt to 217.5 grams of a bi-carbonate salt will render a pH of about 11 whereas a ratio of 325.0 grams of an organic acid to 35.0 grams of a bi-carbonate salt to 15.0 grams of a carbonate salt with give a pH of about 3.

This pH can be incrementally adjusted between these two extremes pursuant to the needs of the application by changing the ratios of the acids and carbonate salts. These high pH and low pH solutions can also be similarly concentrated or diluted depending on use and requirement. Flushing with or adding water to the solution will neutralize the wide pH variations maintaining a non hazardous effect on the surrounding environment.

The invention claimed is:

1. A post-carbonated aqueous cleaning composition comprising of an acid and two or more carbonate salts wherein the carbonated salts and the acids are admixed in an aqueous medium causing the production and loss of carbon dioxide. Wherein the resulting solution has reached a chemical equilibrium and is no longer producing effective amounts of carbon dioxide.

2. The cleaning composition in claim 1, wherein the aqueous medium is water.

3. The cleaning composition in claim 1, wherein the amount of acid and carbonate salt in relation to the amount of water can be adjusted.

4. The cleaning composition in claim 1, wherein the ratio between the acid and carbonate salt can be adjusted.

5. The cleaning composition in claim 1, wherein the acid is selected from a group consisting of citric acid, succinic acid, tartaric acid, adipic acid, oxalic acid and glutaric acid.

6. The cleaning composition in claim 5, wherein the acid is citric acid

7. The cleaning composition in claim 1, wherein the carbonate salts are selected from a group consisting of sodium carbonate, sodium bicarbonate, sodium percarbonate, lithium carbonate, lithium bicarbonate, lithium percarbonate, potassium carbonate, potassium bicarbonate, potassium percarbonate, ammonium carbonate and ammonium bicarbonate.

8. The cleaning composition in claim 7, wherein a first carbonate salt is sodium bicarbonate.

9. The cleaning composition in claim 7, wherein a second carbonate salt is sodium carbonate.
